(19) United States
(12) Patent Application Publication
(10) Pub. No.: US 2014/0293832 A1
(43) Pub. Date: Oct. 2, 2014

(54) METHOD TO SUPPORT GUEST USERS IN AN IMS NETWORK

(71) Applicant: ALCATEL-LUCENT USA INC., Murray Hill, NJ (US)

(72) Inventors: Prashant S. Parikh, Naperville, IL (US); Alan E. Frey, Naperville, IL (US)

(73) Assignee: Alcatel-Lucent USA Inc., Murray Hill, NJ (US)

(21) Appl. No.: 13/851,582

(22) Filed: Mar. 27, 2013

(51) Int. Cl. H04M 15/00

(52) U.S. Cl. CPC H04M 15/57
USPC 370/259

(57) ABSTRACT

A method and system for in an IMS network wherein a service provider can allow guest users who are not subscribers of the service provider to access its IMS core network and place calls to its subscribers. A session ID is associated with a specific call and exchanged between the guest user and a Border Gateway in the IMS core network. Allowed calls are restricted to certain features of the IMS core network and the SP can insure that calls can only be placed to subscribers who have agreed to accept the calls without keeping any guest information in the SP network and complex authorization sequence by subscriber. In addition, the service provider can prevent malicious guest users from gaining access to the IMS core by first requesting to call one subscriber, and then changing data in subsequent call signaling messages to call a different user number free of charge.

### FIELD OF THE INVENTION

The invention relates generally to a method and system for allowing guest users to place calls to subscribers in an Internet Protocol Multimedia Subsystem (IMS) network non-fraudulently.

### BACKGROUND

IMS networks provide Internet services, especially multimedia, to wireless and wireline terminals. An IMS core is typically a collection of elements that are maintained by a network operator, or service provider (SP), to provide telecommunication services to subscribers who have a relationship with the service provider. Some of the elements typically included in a IMS core include a Home Subscriber Server (HSS) that maintains a master database of subscriber profiles including features subscribed to and authorizations, for example, and one or more Call Session Control Functions (CSCF) that route signals within the IMS core. A Border Gateway (BGW) manages the communication protocol and interactions between the IMS core and user devices or external networks, for example, networks maintained by other SPs, user devices over the public Internet or a private network.

The IMS network only allows registered subscribers to make calls; the network requires the subscriber's device to provide valid credentials to register with the network. Often, a SP would like to provide access to its IMS network to non-subscribers, or guest users, so the non-subscriber can try some of the advanced capabilities of the service provider's IMS network (like video calling). Another advantage of this feature is to allow a non-subscriber without a video capable phone to use a Service Provider's web page to make a video call with a SP subscriber who has a video capable device. Since the SP has no way to charge the non-subscriber for the call, the subscriber receiving the call must agree to pay all of the charges for the call. Such an arrangement not only allows the subscriber to enjoy advanced capabilities provided by his service provider on more of his calls, but it also gives non-subscribers an opportunity to experience these capabilities provided by the SP network, which may result in them signing up as customers of the SP in the future. However, while allowing guest users access to the IMS network, the SP will want to restrict the calls the guest user can make; in particular, the guest user can only call a subscriber who has agreed to pay for all charges for a call from the guest to the subscriber. The SP will also want to prevent malicious guest users from gaining access to the IMS network by first requesting to call one subscriber, and then changing data in subsequent call signaling messages to call a different user number free of charge. This can cause fraudulent charges to be added to a subscriber's bill for calls that were not received, and ultimately results in charges incurred to the SP without reimbursement.

Thus, a need exists for to allow SPs to provide subscribers with a feature of receiving calls from guest users that are secure and do not result in fraudulent charges.

### SUMMARY

The invention in one implementation encompasses an improved method and system for enabling guest users to call a specific IMS subscriber of a SP who has informed the SP that they will accept charges for the call.

An improved method and system is executed in a Border Gateway (BGW), for allowing guest users to access an IMS network and comprises of a) receiving a guest call request from a service provider (SP), the guest call request initiated by a non-subscriber of said SP, said guest call request comprising at least an identification of a called SP subscriber, b) returning a session ID and a universal resource locater (URL) of the BGW, wherein the session ID is associated with the called SP subscriber, c) receiving a message from the non-subscriber to connect to the called SP subscriber, said message comprising at least the session ID, d) determining that the session ID in the message matches the session ID associated with the called SP subscriber in step b) and e) if they match, initiating a call to the SP subscriber in the IMS network.

In a further embodiment, a method for allowing guest users to access an IMS network comprises the steps of receiving, at a border gateway (BGW) of the IMS network, a request from a service provider (SP) web server to create one or more secure channels for use by said SP web server in said IMS network, said SP web server operatively connected to a public network, provisioning one or more guest public user IDs (PUIDs) for use in the IMS network in response to the request, receiving a guest call request, associated with a guest user, from the SP web server, said guest call request comprising at least an identification of a called SP subscriber in the IMS network, returning a session ID associated the called SP subscriber, and a universal resource locater (URL) of the BGW to the SP web server, receiving a call setup message from the guest user to connect to the called SP subscriber, said call setup message comprising at least the session ID, determining, by the BGW, that the session ID in the call setup message matches the session ID associated with the called SP subscriber and initiating a call to the called SP subscriber using a guest PUID in the IMS network only if the session ID in the call setup message is associated with the called SP subscriber.

In a further embodiment, an apparatus for allowing guest users to access an IMS network comprises a server adapted to). receive a guest call request from a service provider (SP), the guest call request initiated by a non-subscriber of said SP, said guest call request comprising at least an identification of a called SP subscriber, b) return a session ID and a universal resource locater (URL) of the BGW, wherein the session ID is associated with the called SP subscriber, c) receive a message to connect the non-subscriber to the called SP subscriber, said message comprising at least the session ID, d) determine that the session ID in the message matches the session ID associated with the called SP subscriber in step b) and e) if they match, initiate a call to the SP subscriber in the IMS network.

In accordance with any of the above embodiments the guest PUIDs can only be used for originating calls in the IMS network and have a limited set of features.

In accordance with any of the above embodiments, the method or system further comprises the steps of sending a web page to the non-subscriber from the SP for display on a user device of the non-subscriber and selecting, by the non-subscriber, a link in the web page that initiates the guest call request.

In accordance with a further embodiment the non-subscriber or guest user is required to enter a number identifying the called SP subscriber and a passcode associated with the called SP subscriber to initiate the call request.

In accordance with a further embodiment, an organization, that is also a subscriber of the service provider, is associated with a web server that provides the web page to the non-subscriber, said web page including a link that allows the non-subscriber or guest user to send a call request to the organization.

In any of the above embodiments, calls will only be initiated to called SP subscribers in the IMS network who have agreed to accept calls from a guest user and pay all per call charges.

In any of the above embodiments, a call setup message comprises a protocol message for a video call.

### DESCRIPTION OF THE DRAWINGS

Features of example implementations of the invention will become apparent from the description, the claims, and the accompanying drawings in which:

FIG. 1 is a schematic diagram of an IMS network environment suitable for implementing the various embodiments.

FIG. 2 is a callflow diagram illustrating a method of supporting guest users in an IMS network according to an embodiment.

FIG. 3 is a callflow diagram illustrating a method of supporting guest users authorized by subscriber in an IMS network according to a further embodiment of FIG. 2.

FIG. 4 is a callflow diagram illustrating a method of supporting guest users in an IMS network who are accessing the IMS network though a retail web site.

### DETAILED DESCRIPTION

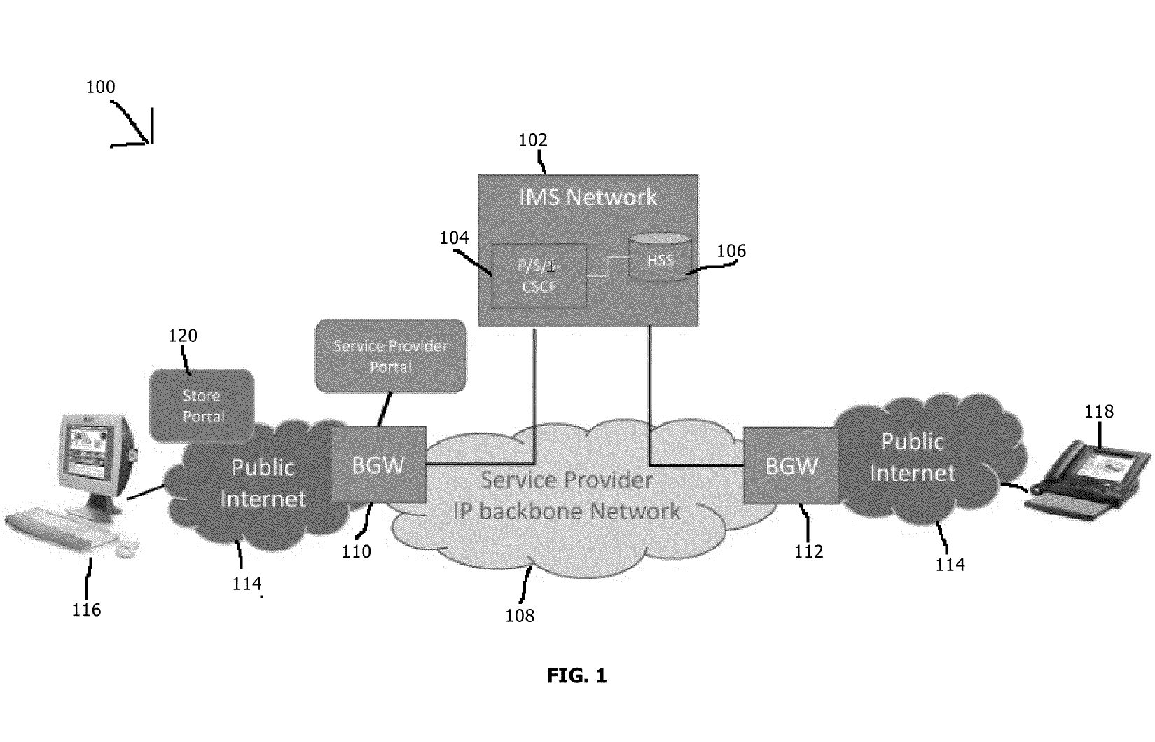

Turning to FIG. 1, an apparatus 100 in one embodiment comprises an IMS Network 102, which includes Call Session Control Function (CSCF) element 104 and a Home Subscriber Server (HSS) 106. Each CSCF may serve somewhat different roles in the network as understood by one of ordinary skill in the art including, for example, a Proxy-CSCF (P-CSCF), a Serving-CSCF (S-CSCF) and an Interrogating-CSCF (I-CSCF). Element 104 is intended to represent all of the CSCF functions.

IMS Network 102 is connected to Service Provider (SP) Internet Protocol (IP) backbone network 108, which includes devices that distribute signals and messages between all network elements. Two of these elements are represented by Border Gateways (BGW) 110 and 112, although the network may include any appropriate number of BGWs. BGWs 110 and 112 provide an interface between SP IP Backbone Network 108 and the public internet 114.

A wide variety of user devices may be connected to public internet 114. As a representative example, FIG. 1 depicts a desktop 116 and a video phone 118, but one of ordinary skill in the art would understand that many different devices could be used. Additionally, a store portal 120 may be connected to public internet 114. This portal would include a web server, for example, for displaying web pages and other information provided by a retail store to on a user device requesting the information.

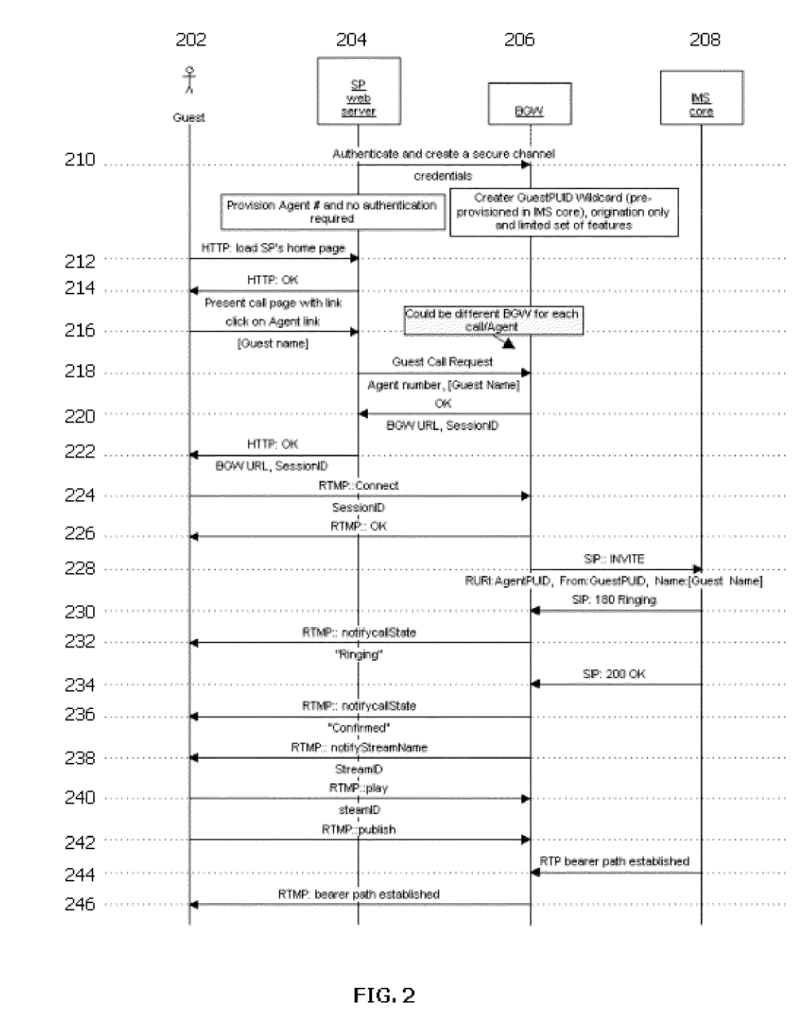

FIG. 2 is a callflow diagram illustrating a method of supporting guest users in an IMS network according to an embodiment. The columns correspond to a non-subscriber, or guest user 202, a web server maintained by a service provider (SP) 204, a Border Gateway (BGW) 206 and an IMS core 208. The callflow diagram illustrates that signals that are exchanged between these elements while accomplishing the method of the embodiment. The guest can be anywhere as long as he/she has access to public internet that can be used to connect to the public web site of the service provider. The user is not limited to one type of browser either it can be any browser technology/OS user prefers.

At step 210, SP web server 204, also called a data center, sends authentication information and credentials to BGW 206 to create a secure channel between the SP web server 204 and IMS core 208. Signal 210 may be sent over a public Internet connection, for example. But in this case, the connection will be secure (e.g., https). This step is performed independently of subsequent call connection steps, typically once when the service is set up, or periodically as desired.

The operation step 210 would be performed when, for example, a new BGW or a new SP web server is deployed in the network. Since SP web server 204 and BGW 206 have a trusted relationship, no further authentication from the subscriber is required. In response to receiving the message of step 210, BGW 206 would register a set of guest Public User IDs (GuestPUIDs) which can only be used to originate calls in the IMS core for guest calls, those calls having a limited set of features. The BGW may also register these PUIDs at initialization. The set of guest PUIDs can be created from pre-provisioned data in BGW or based on a set of rules, but the same set of PUIDs must be provisioned in the HSS. The BGW could also register a wild card PUID, e.g., SP.BGW1.guest**, per BGW; the wild card PUID represents a set of PUIDs, e.g. SP.BGW1.guest00 to SPguest.BGW1.99 PUIDs. The BGW can register these PUIDs with the IMS Core either with (or without) password using UNI interface or unregistered using NNI interface. When BGW wants to create a new call it will use one of its unused/idle PUIDs for the call and mark this PUID in-use inside its database. After the call is completed, BGW will mark this PUID as idle and the same PUID can be reused with other guest/call. Pre-registering the set of GuestPUIDs improves the performance of the system. There is no special provisioning required in the HSS for the agent but the billing system may be programmed to detect Guest PUIDs and do reverse charging if so desired by SP.

When guest user 202 chooses to place a call, the guest user sends a signal at step 212 to SP web server 204 requesting to view the SP home page in a web browser. This signal would be transferred using Hypertext Transfer Protocol (HTTP) or Hypertext Transfer Protocol Secure (HTTPS), for example. At step 214, SP web server 204 responds with a web page that can be used to place calls to subscribers that have agreed to accept the charges for the call.

At step 216, guest user 202 clicks on a link in the webpage that corresponds to the subscriber to whom the call should be placed. A number identifying the subscriber is sent to SP web server 204. A name of guest user 202 can optionally be provided.

At step 218, SP web server 204 checks to see if the subscriber is willing to accept the call from the guest. If so, SP web server 204 sends a guest call request to BGW 206. It is not necessary for all call requests to go to the same BGW. Any representative IMS core network may have a plurality of BGWs and a call to a subscriber may go to any appropriate BGW with whom the SP web server 204 has established a secure channel in step 210. The call request includes the number of the subscriber to be called, and the “caller id display name” to be used for the call as determined by SP web server 204. This could be either a generic name or a name supplied by the guest in step 216.

At step 220, BGW 206 stores this information and responds to the call request by returning a Universal Resource Locater (URL) of BGW 206 and a session ID, or call token, to SP web server 204. This session ID is associated with the subscriber number provided in the call request. In addition, BGW allocates one of the idle guest PUIDs and associates it with this session ID. At step 222, SP web server 204 embeds the BGW URL and the session id to be used for this call in a new HTTP page rendered to the guest user's browser. When this page loads, a call setup message is sent to the BGW URL to set up a call to the called subscriber at step 224. This message also includes the session ID for the call. In an embodiment, the call setup message can be a Real Time Messaging Protocol (RTMP) such as that used in making calls using Flash, but any suitable protocol can be used, for example, Extensible Messaging and Presence Protocol (XMPP), SIP, H.323, or HTTP.

When BGW 206 receives this call setup message, it retrieves the information stored for the received session ID and checks to make sure the called number matches the called number associated with the session ID. If not, BGW 206 will deny the new call request. If called number in the message of step 224 matches the called number associated with the session ID in step 220, BGW 206 continues to set up the call in steps 226 and 228. At step 228, a Session Initiation Protocol message is sent to IMS core 208. This message includes the PUID of the subscriber being called (AgentPUID), a GuestPUID from step 210 and optionally, a name associated with the guest caller and other call context data. In this way, IMS core 208 does not see any difference between this call and a regular to call to a subscriber. Therefore, the IMS core does not need to be changed and any IMS network will be able to handle calls from an authenticated guest user. Charging for the call will be handled by the IMS core in a way that would be understood by one of ordinary skill in the art.

In step 230, IMS core 208 responds to the SIP message with a Ringing message and a call is completed as would be understood by one of ordinary skill in the art in steps 232-246. In addition to a flash client, as depicted in FIG. 2 through the use of an RTMP protocol, other types of clients could be used to set up the call from the guest user's computer, for example a webRTC (Web Real-Time Communication) client.

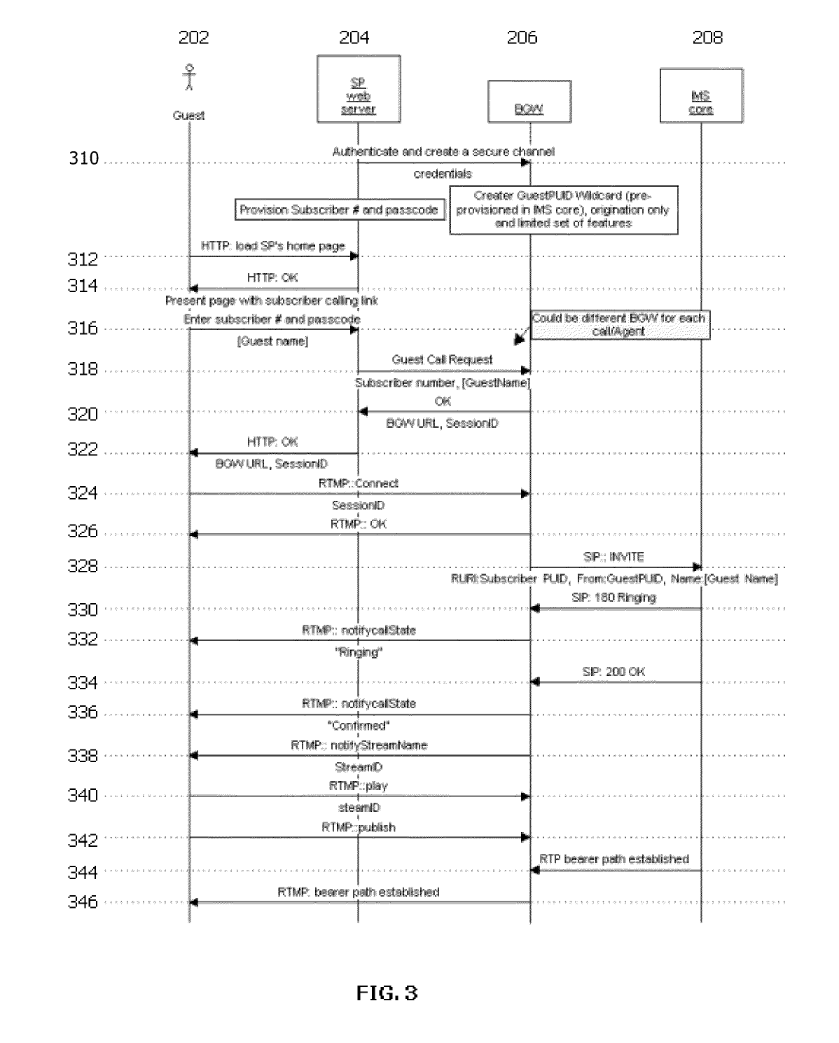

An alternative embodiment is shown in FIG. 3. External guest 202, SP web server 204, BGW 206 and IMS core 208 are the same as shown in FIG. 2. In step 310, however, a subscriber number is provisioned together with a passcode that must be entered to call that subscriber. Similarly to the embodiment of FIG. 2, when guest user 202 chooses to place a call, the guest user sends a signal at step 312 to SP web server 204 requesting to view the SP home page in a web browser. This signal would be transferred using Hyper Text Transfer Protocol (HTTP), for example. At step 314, SP web server 204 responds with a web page containing one or more links that can be used to place calls to subscribers that have agreed to accept the charges for the call. In the embodiment of FIG. 3, however, step 316 asks guest user 202 to enter a subscriber number and passcode, in order to ensure that the subscriber will accept the call and incur charges. An individual subscriber would supply passcodes only to those guest users from whom the subscriber was willing to receive calls. The passcodes could be shared with guest users via an email or any suitable method. The subscriber manages the passcode using the SP web server.

SP web server 204 checks to make sure the entered subscriber number and passcode agree, then steps 318-346 of FIG. 3 are then executed similarly to steps 218-246 of FIG. 2.

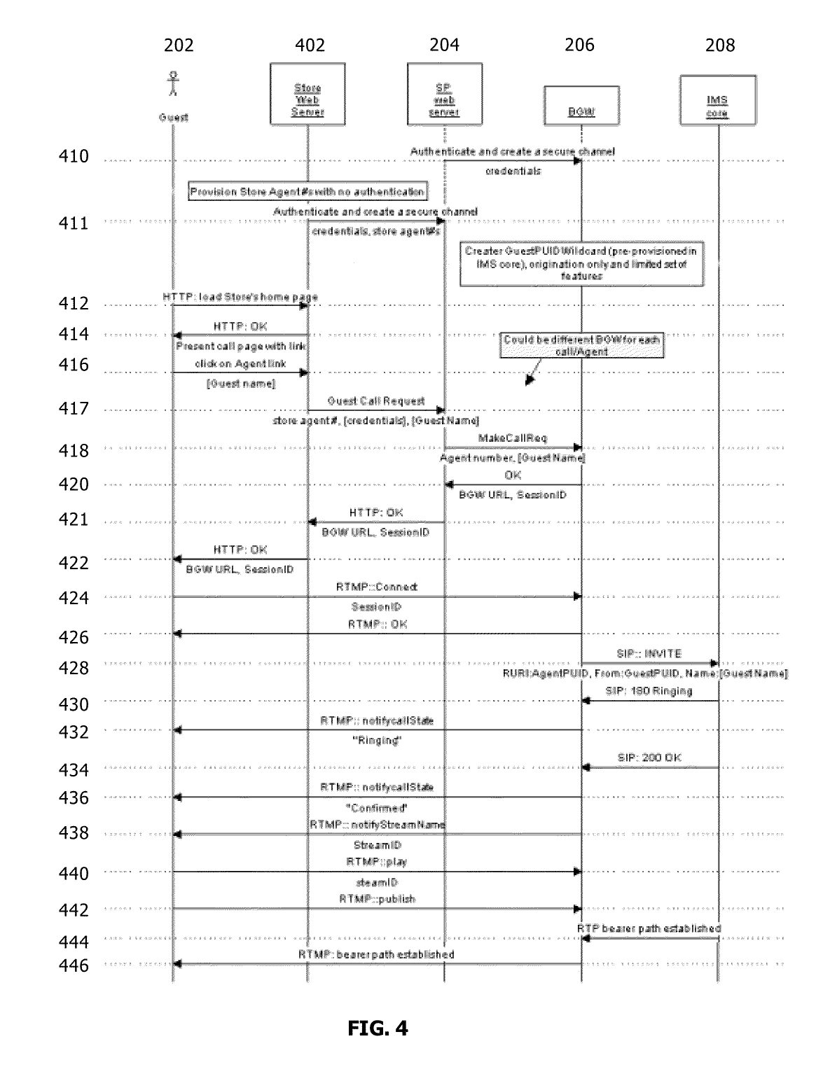

A further embodiment is illustrated in the callflow diagram of FIG. 4. This callflow depicts the exchange of signals between the same guest user 202, SP web server 204, BGW 206 and IMS core 208 for FIGS. 2 and 3. However, FIG. 4 also includes a Store web server 402. This web server can be owned and maintained by any organization that interacts with customers, for example, a large retail chain, an online retailer, or a service provider such as a contractor, medical facility or educational institution.

Similarly to FIG. 2, in step 410 of FIG. 4 SP web server 204 supplies authentication information to BGW 206 to create a secure channel. When the owner of Store web server 402 wants to provide guest users with a feature of placing calls to the store, it provisions a number for the store and performs an authentication process with SP web server 204 at step 411. In a preferred embodiment, the owner of Store web server 402 would be a subscriber of the service provider. In step 411, Store web server 402 creates a secure channel with SP web server by providing credentials and a phone number of the store.

At step 412, similarly to steps 212 of FIG. 2 respectively, a guest user interested in placing a call to the store sends a request to view the stores web page in a browser. The store responds in step 414 with a web page that includes a button or link that allows guest user 202 to call the pre-programmed number provisioned in step 411. This pre-programmed number would connect the guest user with one of the store's associates.

In step 416 of FIG. 4, when guest user 202 clicks on the button or link, the preprogrammed number to be called and a “caller id display name” is communicated to Store web server 402, which passes them along to SP web server 204 as part of a Request Make call message in step 417. This message is part of the HTTP protocol but any suitable message for use in an internet protocol can be used.

Steps 418 and 420 of FIG. 4 are similar to steps 218 and 220 of FIG. 2, wherein SP web server 204 sends a GuestCallReq message to BGW 206, which responds with a BGW URL and session ID. In step 421, SP web server 204 passes the BGW URL and session ID to Store web server 402, after which they are then passed on to the guest's web browser in step 422. From this point, steps 422-446 of FIG. 4 are executed similarly to steps 222-246 of FIG. 2.

The apparatus 100 in FIG. 1 in one example comprises a plurality of components such as one or more of electronic components, hardware components, and computer software components. A number of such components can be combined or divided in the apparatus 100. An example component of the apparatus 100 employs and/or comprises a set and/or series of computer instructions written in or implemented with any of a number of programming languages, as will be appreciated by those skilled in the art.

The apparatus 100 in one example employs one or more computer-readable signal-bearing media. The computer-readable signal-bearing media store software, firmware and/or assembly language for performing one or more portions of one or more implementations of the invention. The computer-readable signal-bearing medium for the apparatus 100 in one example comprise one or more of a magnetic, electrical, optical, biological, and atomic data storage medium. For example, the computer-readable signal-bearing medium comprise floppy disks, magnetic tapes, CD-ROMs, DVD-ROMs, hard disk drives, and electronic memory.

The steps or operations described herein are just for example. There may be many variations to these steps or operations without departing from the spirit of the invention. For instance, the steps may be performed in a differing order, or steps may be added, deleted, or modified.

Although example implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. A method, executed in a Border Gateway (BGW), for allowing guest users to access an IMS network comprising the steps of:
a. receiving a guest call request from a service provider (SP), the guest call request initiated by a non-subscriber of said SP, said guest call request comprising at least an identification of a called SP subscriber;
b. returning a session ID and a universal resource locater (URL) of the BGW, wherein the session ID is associated with the called SP subscriber;
c. receiving a message from the non-subscriber to connect to the called SP subscriber, said message comprising at least the session ID;
d. determining that the session ID in the message matches the session ID associated with the called SP subscriber in step b; and
e. if they match, initiating a call to the SP subscriber in the IMS network.

2. The method of claim 1 further comprising the steps, prior to step a, of:
receiving a request from the SP web server to create one or more secure channels for use by said SP web server in said IMS network, said SP web server operatively connected to a public network; and
provisioning one or more guest public user IDs (PUIDs) for use in the IMS network in response to the request.

3. The method of claim 2 wherein the guest PUIDs can only be used for originating calls in the IMS network and have a limited set of features.

4. The method of claim 1 further comprising, prior to the step of receiving a guest call request, the steps of:
sending a web page to the non-subscriber from the SP for display on a user device of the non-subscriber; and
selecting, by the non-subscriber, a link in the web page that initiates the guest call request.

5. The method of claim 4 wherein the non-subscriber is required to enter a number identifying the called SP subscriber and a passcode associated with the called SP subscriber to initiate the call request.

6. The method of claim 4 wherein an organization, that is also a subscriber of the service provider, is associated with a web server that provides the web page to the non-subscriber, said web page including a link that allows the non-subscriber to send a call request to the organization.

7. A method for allowing guest users to access an IMS network comprising the steps of:
receiving, at a border gateway (BGW) of the IMS network, a request from a service provider (SP) web server to create one or more secure channels for use by said SP web server in said IMS network, said SP web server operatively connected to a public network;
provisioning one or more guest public user IDs (PUIDs) for use in the IMS network in response to the request;
receiving a guest call request, associated with a guest user, from the SP web server, said guest call request comprising at least an identification of a called SP subscriber in the IMS network;
returning a session ID associated the called SP subscriber, and a universal resource locater (URL) of the BGW to the SP web server;
receiving a call setup message from the guest user to connect to the called SP subscriber, said call setup message comprising at least the session ID;
determining, by the BGW, that the session ID in the call setup message matches the session ID associated with the called SP subscriber; and
initiating a call to the called SP subscriber using a guest PUID in the IMS network only if the session ID in the call setup message is associated with the called SP subscriber.

8. The method of claim 7 wherein the guest PUIDs can only be used for originating calls in the IMS network and have a limited set of features.

9. The method of claim 7 wherein calls will only be initiated to called SP subscribers in the IMS network who have agreed to accept calls from a guest user and pay all per call charges.

10. The method of claim 7 wherein the call setup message comprises a protocol message for a video call.

11. The method of claim 7 further comprising, prior to the step of receiving a call request, the steps of
sending a web page to the guest user from the SP web server, for display on a user device of the guest user; and
selecting, by the guest user, a link in the web page that initiates the call request.

12. The method of claim 11 wherein the non-subscriber is required to enter a number identifying an SP subscriber and a passcode associated with that subscriber to initiate the call request.

13. The method of claim 11 wherein an organization, that is also a subscriber of the service provider, is associated with a web server that provides the web page to the non-subscriber, said web page including a link that allows the non-subscriber to send a call request to the organization.

14. An apparatus for allowing guest users to access an IMS network comprising:
a server adapted to:
a. receive a guest call request from a service provider (SP), the guest call request initiated by a non-subscriber of said SP, said guest call request comprising at least an identification of a called SP subscriber;
b. return a session ID and a universal resource locater (URL) of the BGW, wherein the session ID is associated with the called SP subscriber;
c. receive a message to connect the non-subscriber to the called SP subscriber, said message comprising at least the session ID;
d. determine that the session ID in the message matches the session ID associated with the called SP subscriber in step b; and
e. if they match, initiate a call to the SP subscriber in the IMS network.

15. The method of claim 14 further comprising the steps, prior to step a, of:
receiving a request from the SP web server to create one or more secure channels for use by said SP web server in said IMS network, said SP web server operatively connected to a public network; and
provisioning one or more guest public user IDs (PUIDs) for use in the IMS network in response to the request wherein the guest PUIDs can only be used for originating calls in the IMS network and have a limited set of features.

16. The method of claim 14 wherein calls will only be initiated to called SP subscribers in the IMS network who have agreed to accept calls from a guest user and pay all per call charges.

17. The method of claim 14 wherein the call setup message comprises a protocol message for a video call.

18. The method of claim 14 further comprising, prior to the step of receiving a call request, the steps of
sending a web page to the guest user from the SP web server, for display on a user device of the guest user;
selecting, by the guest user, a link in the web page that initiates the call request.

19. The method of claim 18 wherein the non-subscriber is required to enter a number identifying an SP subscriber and a passcode associated with that subscriber to initiate the call request.

20. The method of claim 18 wherein an organization, that is also a subscriber of the service provider, is associated with a web server that provides the web page to the non-subscriber, said web page including a link that allows the non-subscriber to send a call request to the organization.
